(19) United States
(12) Patent Application Publication
(10) Pub. No.: US 2017/0174888 A1
(43) Pub. Date: Jun. 22, 2017

(54) TRANSPARENT CONDUCTIVE FILM, STRUCTURE, INFORMATION INPUT DEVICE, AND ELECTRODE PRODUCTION METHOD

(71) Applicant: Dexerials Corporation, Tokyo (JP)

(72) Inventors: Ryosuke IWATA, Tokyo (JP); Yasuhisa ISHII, Kanuma-shi (JP); Mikihisa MIZUNO, Utsunomiya-shi (JP)

(73) Assignee: Dexerials Corporation, Tokyo (JP)

(21) Appl. No.: 15/338,720

(22) Filed: Oct. 31, 2016

(30) Foreign Application Priority Data
Dec. 22, 2015 (JP) 2015-250376

(51) Int. Cl. C09B 47/00; H01B 1/02; D06M 13/355; H01B 5/14; C09B 47/04; D06M 13/352

(52) U.S. Cl. CPC C09B 47/00; C09B 47/04; D06M 13/352; D06M 13/355; H01B 5/14; H01B 1/02; G06F 3/0412

(57) ABSTRACT

Provided is a transparent conductive film that suppresses deterioration of display characteristics due to reduced contrast and that has excellent long-term conductivity, even when exposed to harsh conditions. The transparent conductive film includes one or more metal nanowire bodies and a colored compound adsorbed onto the metal nanowire bodies. The colored compound includes a first dye that includes a macrocyclic π-conjugated moiety and a moiety having a functional group that exhibits adsorptivity with respect to a constituent metal of the metal nanowire bodies.

### TECHNICAL FIELD

The present disclosure relates to a transparent conductive film, a structure, an information input device, and an electrode production method, and in particular relates to a transparent conductive film including metal nanowires formed by metal nanowire bodies and a colored compound adsorbed thereon, a structure including this transparent conductive film, an information input device into which this structure is incorporated, and a production method for an electrode that includes the aforementioned transparent conductive film.

### BACKGROUND

A large number of base plates for use in information input devices, such as touch panel sensors and organic EL lighting, are prepared by forming a transparent conductive film of a metal oxide, such as indium tin oxide (ITO), on a substrate, such as glass or a plastic film made from PET or the like.

However, in recent years, there has been rapid expansion in the use of conductive films including nanowires made from metal as substitutes for transparent conductive films of metal oxide such as described above. These transparent conductive films including nanowires made from metal have been attracting interest as next generation transparent conductive films due to their ease of shaping and ability to realize low resistance.

However, in a situation in which a conventional transparent conductive film including nanowires made from metal is, for example, disposed at a display surface-side of a display panel, diffuse reflection of external light by the surfaces of the nanowires causes black displayed by the display panel to appear slightly brighter, which may be referred to as a “black floating (black level misadjustment)” phenomenon. The black floating phenomenon is a factor that leads to deterioration of display characteristics due to reduced contrast.

In one method that has been proposed as a strategy for suppressing occurrence of the black floating phenomenon, a transparent conductive film is prepared using nanowires made from metal that have a colored compound (dye) adsorbed thereon (for example, refer to PTL 1).

### CITATION LIST

### Patent Literature

PTL 1: JP 2012-190780 A

### SUMMARY

However, since dyes generally have poor conductivity, mixing of a low-conductivity dye with nanowires made from metal may lead to formation of a conductive film that does not have sufficient conductivity. In particular, conductivity of the conductive film may deteriorate if the conductive film is exposed to harsh conditions for a long period. Therefore, in a situation in which a dye is used, it is normally necessary to reduce sheet resistance by performing a pressing process such as calendering after a transparent conductive film has been formed on a substrate. However, this pressing process is a factor that impairs producibility of the transparent conductive film.

The present disclosure aims to solve the various conventional problems described above and achieve the following objective. Specifically, an objective of the present disclosure is to provide a transparent conductive film that suppresses deterioration of display characteristics due to reduced contrast and that has excellent long-term conductivity, even when exposed to harsh conditions, and also to provide a structure including this transparent conductive film, an information input device including this structure, and an electrode production method having high productivity that can be used to produce an electrode that suppresses deterioration of display characteristics due to reduced contrast and that has excellent long-term conductivity, even when exposed to harsh conditions.

The inventors carried out diligent investigation in order to achieve the objective described above and discovered, as a result of this investigation, that when a dye including specific moieties is adsorbed onto metal nanowire bodies as a colored compound, it is possible to obtain a transparent conductive film that suppresses deterioration of display characteristics and that has excellent long-term conductivity. This discovery led to the present disclosure.

The present disclosure is based on these findings made by the inventors and provides the following as a solution to the problems described above. Specifically, the present disclosure provides:

<1> A transparent conductive film comprising:

one or more metal nanowire bodies; and

a colored compound adsorbed onto the metal nanowire bodies, wherein

the colored compound includes a first dye that includes a macrocyclic π-conjugated moiety and a moiety having a functional group that exhibits adsorptivity with respect to a constituent metal of the metal nanowire bodies.

In the transparent conductive film described in <1>, the tendency of the first dye to impair conductivity can be reduced as a result of the first dye including the macrocyclic π-conjugated moiety, and diffuse reflection of light by the surfaces of the metal nanowire bodies can be prevented as a result of the first dye absorbing visible light. Moreover, the first dye can be effectively adsorbed onto the metal nanowire bodies as a result of the first dye including the moiety having the functional group that exhibits adsorptivity with respect to the constituent metal of the metal nanowire bodies. Consequently, the above-described transparent conductive film suppresses deterioration of display characteristics due to reduced contrast and has excellent long-term conductivity, even when exposed to harsh conditions.

<2> The transparent conductive film described in <1>, wherein

the functional group that exhibits adsorptivity with respect to the constituent metal is at least one selected from the group consisting of a sulfo group, a sulfonyl group, a sulfonamide group, a carboxylic acid group, an aromatic amino group, an amide group, a phosphate group, a phosphino group, a silanol group, an epoxy group, an isocyanate group, a cyano group, a vinyl group, a thiol group, a sulfide group, a carbinol group, an ammonium group, a pyridinium group, a hydroxy group, and a methyl group.

<3> The transparent conductive film described in <1> or <2>, wherein

the number of functional groups in the first dye that exhibit adsorptivity with respect to the constituent metal is at least two per each macrocyclic π-conjugated moiety in the first dye.

<4> The transparent conductive film described in any one of <1> to <3>, wherein

the macrocyclic π-conjugated moiety is at least one selected from the group consisting of a porphyrin, a chlorin, a corrole, a norcorrole, a subporphyrin, a phthalocyanine, a naphthalocyanine, a subphthalocyanine, an anthracocyanine, a tetraazaporphyrin, a bacteriochlorin, and a benzoporphyrin.

<5> The transparent conductive film described in any one of <1> to <4>, wherein

the first dye has a number-average molecular mass of from 1,000 to 2,000.

<6> The transparent conductive film described in any one of <1> to <5>, wherein

the colored compound further includes a second dye including a chromophore that absorbs visible region light, but does not have a macrocyclic π-conjugated moiety, and a moiety having a functional group that exhibits adsorptivity with respect to the constituent metal of the metal nanowire bodies.

<7> The transparent conductive film described in <6>, wherein

the chromophore that absorbs visible region light, but does not have a macrocyclic π-conjugated moiety, is at least one selected from the group consisting of a stilbene derivative, an indophenol derivative, a diphenylmethane derivative, an anthraquinone derivative, a triphenylmethane derivative, a diazine derivative, an indigoid derivative, a xanthene derivative, an oxazine derivative, an acridine derivative, a thiazine derivative, an azo compound, and a metal-containing complex.

<8> The transparent conductive film described in <6> or <7>, wherein

either or both of the first dye and the second dye have a number-average molecular mass of from 1,000 to 2,000.

<9> The transparent conductive film described in any one of <1> to <8>, wherein

the constituent metal of the metal nanowire bodies is silver.

<10> An electrode production method comprising

forming the transparent conductive film described in any one of <1> to <8> on a substrate, wherein

pressing is not performed after the forming of the transparent conductive film.

<11> A structure comprising:
a substrate; and

the transparent conductive film described in any one of <1> to <9> on the substrate.

<12> An information input device comprising the structure described in <11>.

According to the present disclosure, it is possible to solve the various conventional problems described above and achieve the objective described above. Moreover, it is possible to provide a transparent conductive film that suppresses deterioration of display characteristics due to reduced contrast and that has excellent long-term conductivity, even when exposed to harsh conditions, and to provide a structure including this transparent conductive film, an information input device including this structure, and an electrode production method having good productivity that can be used to produce an electrode that suppresses deterioration of display characteristics due to reduced contrast and that has excellent long-term conductivity, even when exposed to harsh conditions.

### BRIEF DESCRIPTION OF THE DRAWINGS

In the accompanying drawings:

FIG. 1 is a schematic view illustrating a first embodiment of an electrode including a transparent conductive film according to the present disclosure;

FIG. 2 is a schematic view illustrating a second embodiment of an electrode including a transparent conductive film according to the present disclosure;

FIG. 3 is a schematic view illustrating a third embodiment of an electrode including a transparent conductive film according to the present disclosure;

FIG. 4 is a schematic view illustrating a fourth embodiment of an electrode including a transparent conductive film according to the present disclosure;

FIG. 5 is a schematic view illustrating a fifth embodiment of an electrode including a transparent conductive film according to the present disclosure; and

FIG. 6 is a schematic view illustrating a sixth embodiment of an electrode including a transparent conductive film according to the present disclosure.

### DETAILED DESCRIPTION

### Transparent Conductive Film

A transparent conductive film according to the present disclosure at least includes one or more metal nanowire bodies and a specific colored compound adsorbed onto the metal nanowire bodies, and may further include a binder (transparent resin material) and other components as necessary.

Diffuse reflection of light by the surfaces of the metal nanowire bodies can be prevented as a result of the colored compound being adsorbed onto the metal nanowire bodies because the colored compound absorbs visible light or the like.

In the present description, the metal nanowire bodies having the colored compound adsorbed thereon are referred to as “metal nanowires”. The metal nanowires may be inclusive not only of metal nanowire bodies having the colored compound adsorbed onto the entirety thereof, but also metal nanowire bodies having the colored compound adsorbed onto at least part thereof.

<Metal Nanowire Bodies>

The metal nanowire bodies are fine wires made from metal that have nanometer-scale diameters.

The constituent metal of the metal nanowire bodies can be selected as appropriate depending on the objective, without any specific limitations, and may for example be Ag, Au, Ni, Cu, Pd, Pt, Rh, Ir, Ru, Os, Fe, Co, Sn, Al, Tl, Zn, Nb, Ti, In, W, Mo, Cr, V, or Ta. Any one of such metals may be used individually, or any two or more of such metals may be used in combination.

Of these metals, silver or gold is preferable as the constituent metal of the metal nanowire bodies, with silver being more preferable, since these metals have high conductivity.

The average minor axis diameter of the metal nanowire bodies can be selected as appropriate depending on the objective, without any specific limitations, and is preferably greater than 1 nm and no greater than 500 nm. As a result of the average minor axis diameter of the metal nanowire bodies being greater than 1 nm, it is possible to suppress reduction of conductivity of the metal nanowire bodies and obtain a transparent conductive film that serves as a good conductive layer. On the other hand, as a result of the average minor axis diameter of the metal nanowire bodies being no greater than 500 nm, it is possible to prevent deterioration of total light transmittivity of the transparent conductive film including these metal nanowire bodies, and also to prevent occurrence of high haze. For the same reasons, the average minor axis diameter of the metal nanowire bodies is more preferably from 10 nm to 100 nm.

The average major axis length of the metal nanowire bodies can be selected as appropriate depending on the objective, without any specific limitations, and is preferably from 1 μm to 100 μm. As a result of the average major axis length of the metal nanowire bodies being at least 1 μm, the metal nanowire bodies tend to readily join to one another such that the transparent conductive film including these metal nanowire bodies serves as a good conductive film. On the other hand, as a result of the average major axis length of the metal nanowire bodies being no greater than 100 μm, it is possible to prevent reduction of total light transmittivity of the transparent conductive film including these metal nanowire bodies, and also to prevent reduction of dispersibility of the metal nanowires in a dispersion liquid used in production of the transparent conductive film. For the same reasons, the average major axis length of the metal nanowire bodies is more preferably from 5 μm to 50 μm further preferably from 10 μm to 50 μm, and particularly preferably from 10 μm to 30 μm.

Note that the average minor axis diameter and the average major axis length of the metal nanowire bodies are respectively a number-average minor axis diameter and a number-average major axis length that can be measured using a scanning electron microscope. More specifically, at least 100 of the metal nanowire bodies are measured and an image analyzer is used to calculate a projected diameter and a projected area of each nanowire from an electron microscope photograph. The projected diameter is taken to be the minor axis diameter. The major axis length is calculated based on the following formula.

Major axis length=Projected area/Projected diameter

The average minor axis diameter is the arithmetic mean of the minor axis diameters. The average major axis length is the arithmetic mean of the major axis lengths.

Furthermore, the metal nanowire bodies may alternatively have a wire shape connecting metal nanoparticles in a bead-string shape. No specific limitations are placed on the length in such a situation.

<Colored Compound>

The colored compound is a compound that is adsorbed onto the metal nanowire bodies and that absorbs visible region light. In the present description, “visible region light” refers to a wavelength band from approximately 360 nm or greater to 830 nm or less. The colored compound that is used in the present disclosure includes a first dye that includes a macrocyclic π-conjugated moiety and a moiety having a functional group that exhibits adsorptivity with respect to the constituent metal of the metal nanowire bodies (hereinafter, also referred to simply as a “metal-adsorptive functional group”), and may optionally include other dyes. The first dye may for example be represented by general formula (1): [R—X], or general formula (2): [{R—R′}—X] (where R is a chromophore having a macrocyclic π-conjugated moiety, R′ is a chromophore that absorbs visible region light, but does not have a macrocyclic π-conjugated moiety, and X is a moiety having a functional group that exhibits adsorptivity with respect to the constituent metal of the metal nanowire bodies). Furthermore, the first dye may include a plurality of the any of the chromophore R, the chromophore R′, and the moiety X defined for the preceding formulae.

<<First Dye>>

The first dye includes a macrocyclic π-conjugated moiety. The macrocyclic π-conjugated moiety composes at least part of the chromophore R in general formula (1) or (2) described above. In the present description, “macrocyclic π-conjugated moiety” refers to a moiety in which a plurality of ring structures are present as constituent parts of a large planar ring structure in which π electrons are conjugated. As a result of the macrocyclic π-conjugated moiety having a planar structure such as described above, the first dye including the macrocyclic π-conjugated moiety is less bulky than other dyes and does not tend to impair conductivity. Moreover, diffuse reflection of light by the surfaces of the metal nanowire bodies can be prevented as a result of visible light absorption by the first dye that is used as the colored compound. Furthermore, through use of the first dye as the colored compound, it is possible to obtain a transparent conductive film that suppresses deterioration of display characteristics due to reduced contrast and that has excellent long-term conductivity, even when exposed to harsh conditions.

The macrocyclic π-conjugated moiety can be selected as appropriate depending on the objective, without any specific limitations. However, from a viewpoint of further improving conductivity and optical characteristics of the transparent conductive film, the macrocyclic π-conjugated moiety is preferably at least one selected from the group consisting of a porphyrin, a chlorin, a corrole, a norcorrole, a subporphyrin, a phthalocyanine, a naphthalocyanine, a subphthalocyanine, an anthracocyanine, a tetraazaporphyrin, a bacteriochlorin, and a benzoporphyrin, and is more preferably at least one selected from the group consisting of a phthalocyanine, a porphyrin, and a tetraazaporphyrin. Any one of such macrocyclic π-conjugated moieties may be used individually, or any two or more of such macrocyclic π-conjugated moieties may be used in combination.

The first dye also includes a moiety having a functional group that exhibits adsorptivity with respect to the constituent metal of the metal nanowire bodies that are used (i.e., a metal-adsorptive functional group). The aforementioned moiety corresponds to the moiety X in general formula (1) or (2) described above. As a result of the first dye that includes the aforementioned moiety being used as the colored compound, the colored compound can be effectively adsorbed onto the metal nanowire bodies.

The metal-adsorptive functional group can be selected as appropriate depending on the objective, without any specific limitations, and may for example be a functional group including an atom such as N (nitrogen), S (sulfur), or O (oxygen) that can coordinate with the constituent metal of the metal nanowire bodies. In particular, the metal-adsorptive functional group is preferably at least one selected from the group consisting of a sulfo group (inclusive of sulfonic acid salts), a sulfonyl group, a sulfonamide group, a carboxylic acid group (inclusive of carboxylic acid salts), an aromatic amino group, an amide group, a phosphate group (inclusive of phosphoric acid salts and phosphoric acid esters), a phosphino group, a silanol group, an epoxy group, an isocyanate group, a cyano group, a vinyl group, a thiol group, a sulfide group, a carbinol group, an ammonium group, a pyridinium group, a hydroxy group, and a methyl group, and is more preferably at least one selected from the group consisting of a sulfo group, a thiol group, a hydroxy group, a carboxylic acid group (inclusive of carboxylic acid salts), an ammonium group, and a pyridinium group. The groups listed above exhibit particularly good adsorptivity with respect to metal and enable strong bonding between the metal nanowire bodies and the first dye used as the colored compound. Consequently, deterioration of conductivity can be suppressed and good characteristics can be maintained even when the transparent conductive film is exposed to harsh conditions for a long period. It should be noted that at least one metal-adsorptive functional group such described above is present in the first dye (i.e., in each molecule of the first dye) that is used as the colored compound, and two or more metal-adsorptive functional groups such as described above may be present in the first dye (i.e., in each molecule of the first dye). Moreover, a plurality of different types of metal-adsorptive functional groups may be present in the first dye.

In the moiety having the metal-adsorptive functional group, a part of the moiety that is exclusive of the metal-adsorptive functional group is not specifically limited and may for example be an alkyl group or an alkylene group.

The following shows one example of a general formula of the first dye for a situation in which the first dye includes a phthalocyanine structure as the macrocyclic π-conjugated moiety.

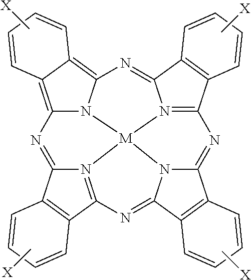

In the general formula shown above, M represents a freely selected metal element that may be present or absent. However, from a viewpoint of light resistance, it is preferable that M is present (i.e., that a metal is coordinated). M may for example be copper, iron, zinc, titanium, vanadium, nickel, palladium, platinum, lead, silicon, bismuth, cadmium, lanthanum, terbium, cerium, europium, beryllium, magnesium, cobalt, ruthenium, manganese, chromium, or molybdenum. Furthermore, X represents a moiety having a metal-adsorptive functional group and at least one moiety X is present.

As described above, the number of metal-adsorptive functional groups in the first dye is not specifically limited. However, it is preferable that at least two metal-adsorptive functional groups are present per each macrocyclic π-conjugated moiety in the first dye. When the number of metal-adsorptive functional groups is at least two per each macrocyclic π-conjugated moiety, adsorptivity of the first dye with respect to the metal nanowire bodies can be improved and, as a result, particularly good characteristics can be maintained even when the transparent conductive film is exposed to harsh conditions for a long period.

The number-average molecular mass of the first dye can be selected as appropriate depending on the objective, without any specific limitations, and is preferably from 1,000 to 2,000. As a result of the number-average molecular mass of the first dye being at least 1,000, dispersibility of the metal nanowires after adsorption can be maintained and negative influence on characteristics of the transparent conductive film can be reduced. Moreover, as a result of the number-average molecular mass of the first dye being no greater than 2,000, the first dye exhibits good adsorptivity with respect to the metal nanowire bodies, deterioration of display characteristics can be efficiently suppressed, and particularly good characteristics can be maintained even when the transparent conductive film is exposed to harsh conditions for a long period.

The number-average molecular mass can for example be obtained by gel permeation chromatography (GPC, polystyrene-converted value).

<<Second Dye>>

In addition to the first dye described above, the colored compound that is used in the present disclosure preferably further includes a second dye including a chromophore that absorbs visible region light, but does not have a macrocyclic π-conjugated moiety, and a moiety having a functional group that exhibits adsorptivity with respect to the constituent metal of the metal nanowire bodies. Optical characteristics of the transparent conductive film, such as a Δreflection L* value, can be improved through the second dye being adsorbed onto the metal nanowires in addition to the first dye. More specifically, the aforementioned second dye may for example be represented by general formula (3): [R′—X] (where R′ is a chromophore that absorbs visible region light, but does not have a macrocyclic π-conjugated moiety, and X is a moiety having a functional group that exhibits adsorptivity with respect to the constituent metal of the metal nanowire bodies). Furthermore, the second dye may include a plurality of either or both of the chromophore R′ and the moiety X defined for the preceding formula.

In the second dye, the chromophore R′ that absorbs visible region light, but does not have a macrocyclic π-conjugated moiety, may for example be a stilbene derivative, an indophenol derivative, a diphenylmethane derivative, an anthraquinone derivative, a triphenylmethane derivative, a diazine derivative, an indigoid derivative, a xanthene derivative, an oxazine derivative, an acridine derivative, a thiazine derivative, an azo compound, or a metal-containing complex. Any one of such chromophores may be used individually, or any two or more of such chromophores may be used in combination.

In the second dye, the moiety X having a functional group that exhibits adsorptivity with respect to the constituent metal of the metal nanowire bodies may be the same as the moiety X in the first dye having a functional group that exhibits adsorptivity with respect to the constituent metal of the metal nanowire bodies.

The second dye can be prepared using a raw material dye such as an acidic dye or a direct dye as a compound including the chromophore R′. More specifically, examples of sulfo group-containing raw material dyes that can be used include Kayakalan Bordeaux BL, Kayakalan Brown GL, Kayakalan Gray BL167, Kayakalan Yellow GL143, Kayakalan Black 2RL, Kayakalan Black BGL, Kayakalan Orange RL, Kayarus Cupro Green G, Kayarus Supra Blue MRG, and Kayarus Supra Scarlet BNL200 produced by Nippon Kayaku Co., Ltd.; Lanyl Olive BG and Lanyl Black BG E/C produced by Taoka Chemical Co., Ltd.; and Acid Black 52, Acid Red 52, Acid Red 1, Acid Red 9, Acid Red 13, Acid Red 26, Acid Red 114, Acid Red 151, Acid Red 289, Chromotrope 2B, Crocein Scarlet 3B, Acid Violet 49, Acid Green 3, Brilliant Blue G, Brilliant Blue R, Xylene Cyanol FF, Chlorantine Fast Red 5B, Direct Red 80, Direct Scarlet B, Azo Blue, and Direct Violet 1 produced by Tokyo Chemical Industry Co., Ltd. Other examples include, Kayalon Polyester Blue 2R-SF, Kayalon Microester Red AQ-LE, Kayalon Polyester Black ECX300, and Kayalon Microester Blue AQ-LE produced by Nippon Kayaku Co., Ltd. Examples of carboxy group-containing raw material dyes that can be used include pigments for dye-sensitized solar cells such as Ru complexes exemplified by N3, N621, N712, N719, N749, N773, N790, N820, N823, N845, N945, K9, K19, K23, K27, K29, K51, K60, K66, K69, K73, K77, Z235, Z316, Z907, Z907Na, Z910, Z991, CYC-B1, and HRS-1; and organic pigments exemplified by Anthocyanine, PPDCA, PTCA, BBAPDC, NKX-2311, NKX-2510, NKX-2553 (produced by Hayashibara Co., Ltd.), NKX-2554 (produced by Hayashibara Co., Ltd.), NKX-2569, NKX-2586, NKX-2587 (produced by Hayashibara Co., Ltd.), NKX-2677 (produced by Hayashibara Co., Ltd.), NKX-2697, NKX-2753, NKX-2883, NK-5958 (produced by Hayashibara Co., Ltd.), NK-2684 (produced by Hayashibara Co., Ltd.), Eosin Y, Mercurochrome, MK-2 (produced by Soken Chemical & Engineering Co., Ltd.), D77, D102 (produced by Mitsubishi Paper Mills, Ltd.), D120, D131 (produced by Mitsubishi Paper Mills, Ltd.), D149 (produced by Mitsubishi Paper Mills, Ltd.), D150, D190, D205 (produced by Mitsubishi Paper Mills, Ltd.), D358 (produced by Mitsubishi Paper Mills, Ltd.), JK-1, JK-2, JK-5, Polythiohene Dye, Pendant type polymer, and Cyanine Dye (P3TTA, C1-D, SQ-3, B1).

The number-average molecular mass of the second dye can be selected as appropriate depending on the objective, without any specific limitations, and is preferably from 400 to 2,000. As a result of the number-average molecular mass of the second dye being at least 400, dispersibility of the metal nanowires after adsorption can be maintained and negative influence on characteristics of the transparent conductive film can be reduced. On the other hand, as a result of the number-average molecular mass of the second dye being no greater than 2,000, the second dye exhibits good adsorptivity with respect to the metal nanowire bodies, deterioration of display characteristics can be efficiently suppressed, and particularly good characteristics can be maintained even when the transparent conductive film is exposed to harsh conditions for a long period.

For the same reasons as described above, it is preferable that either or both of the first dye and the second dye have a number-average molecular mass of from 1,000 to 2,000.

<<Colored Compound Production Method>>

The method by which the colored compound, such as the first dye and the second dye, is produced can be selected as appropriate depending on the objective, without any specific limitations, and may for example be a method involving (I) preparing a solution in which a compound raw material including a chromophore that is to be included in the colored compound is dissolved or dispersed in a solvent and a solution in which a compound including a metal-adsorptive functional group is dissolved in a solvent, and (II) mixing the two solutions prepared as described above in order to cause precipitation of the colored compound.

The solvent may for example be water; an alcohol such as methanol, ethanol, n-propanol, i-propanol, n-butanol, i-butanol, sec-butanol, or tert-butanol; a ketone such as cyclohexanone or cyclopentanone; an amide such as N,N-dimethylformamide (DMF); or a sulfide such as dimethyl sulfoxide (DMSO). The solvent is selected as most appropriate in consideration of solubility of the raw materials and the product, and may be a single type of solvent or a combination of two or more types of solvents. Furthermore, the solvent may be added partway through. The temperature of the solutions can be determined in consideration of the solubility of the raw materials and the product, and the rate of reaction, without any specific limitations.

In a situation in which a first dye is to be prepared that includes both a chromophore R and a chromophore R′ such as represented in the previously described general formula (2), a compound including the chromophore R and a compound including the chromophore R′ may be caused to chemically react in order to bond the chromophore R and the chromophore R′ to one another through a new covalent or non-covalent bond. Moreover, in a situation in which a second dye is to be prepared such as represented by the previously described general formula (3), a compound having a metal-adsorptive functional group may be caused to chemically react with a compound including a chromophore R′ in order to add the metal-adsorptive functional group through a new covalent or non-covalent bond. Furthermore, a compound having a metal-adsorptive functional group may be caused to chemically react with a compound including a chromophore R, a compound including a chromophore R and a chromophore R′, or a compound including a chromophore R′ in order to add the metal-adsorptive functional group through a new covalent or non-covalent bond. Moreover, a self-organizing material may be used as the compound having a metal-adsorptive functional group. Also note that the metal-adsorptive functional group may form part of the chromophore R and/or the chromophore R′.

No specific limitations are placed on the form of bonding in the first dye between the chromophore R and the moiety X or between the chromophore R′ and the moiety X, or on the form of bonding in the second dye between the chromophore R′ and the moiety X having the metal-adsorptive functional group. The bonding may for example be non-covalent bonding (for example, hydrogen bonding, ionic bonding, hydrophobic interactions, or Van der Waals forces).

Furthermore, bonding between the chromophore R and the chromophore R′ in the first dye represented by general formula (2) may be covalent bonding or non-covalent bonding (for example, hydrogen bonding, ionic bonding, hydrophobic interactions, or Van der Waals forces).

Herein, it is preferable that neither the first dye nor the second dye includes an alkyl-substituted amino group. The reason for this is that an alkyl-substituted amino group may cause corrosion of the metal nanowire bodies. Herein, “alkyl-substituted amino group” refers to an amino group in which all carbon atoms bonded directly to the N atom have sp^{a} hybridized orbitals.

<Production Method of Metal Nanowires (Metal Nanowire Bodies Having Colored Compound Adsorbed Thereon)>

The metal nanowires can for example be obtained as a metal nanowire dispersion liquid by (a) preparing a colored compound solution containing the colored compound and a solvent, (b) preparing a metal nanowire body dispersion liquid containing the metal nanowire bodies and a solvent, (c) combining the colored compound solution and the metal nanowire body dispersion liquid and causing adsorption of the colored compound onto the surfaces of the metal nanowire bodies by, for example, stirring, heating, or leaving the resultant mixture to stand, and (d) removing any of the colored compound that has not been adsorbed.

The solvent of the colored compound solution that is used in (a) described above is preferably an appropriately selected solvent that enables dissolution and/or dispersion of a specific concentration of the colored compound and that is compatible with the solvent of the metal nanowire body dispersion liquid. Note that “dispersion of the colored compound” is also inclusive of a state in which “the colored compound is dispersed as aggregates”.

One specific example of a method for removing colored compound that has not been adsorbed in (d) is a method in which the colored compound solution is placed inside a filter paper tube and colored compound that has not been adsorbed is removed by separation through filtration. In the aforementioned method, washing may be performed by adding further solvent (the solvent may be the same as the solvent of the colored compound solution or a different solvent, and may be a mixed solvent) into the filter paper tube through an opening therein in order to further remove colored compound that has not been adsorbed. Furthermore, an additive such as a dispersant, a surfactant, a defoamer, or a viscosity modifier may be added as necessary. Dispersing may for example be performed by a magnetic stirrer, shaking by hand, jar mill stirring, a mechanical stirrer, ultrasound irradiation, or a wet disperser.

<Binder (Transparent Resin Material)>

A binder (transparent resin material) may be used in order to disperse the metal nanowires. The binder can be selected as appropriate depending on the objective, without any specific limitations, and may for example be a known natural or synthetic polymer resin that is transparent. Moreover, the binder may be a thermoplastic resin, a thermosetting resin, a positive-type photosensitive resin, or a negative-type photosensitive resin.

<<Thermoplastic Resin>>

The thermoplastic resin can be selected as appropriate depending on the objective, without any specific limitations, and may for example be polyvinyl chloride, a vinyl chloride-vinyl acetate copolymer, polymethyl methacrylate, nitrocellulose, chlorinated polyethylene, chlorinated polypropylene, vinylidene fluoride, ethylcellulose, hydroxypropyl methylcellulose, polyvinyl alcohol, or polyvinyl pyrrolidone.

<<Thermosetting Resin>>

The thermosetting resin can be selected as appropriate depending on the objective, without any specific limitations, and may for example be a composition including a polymer (for example, a polyvinyl alcohol, a polyvinyl acetate-based polymer (for example, saponified polyvinyl acetate), a polyoxyalkylene-based polymer (for example, polyethylene glycol or polypropylene glycol), or a cellulosic polymer (for example, methylcellulose, viscose, hydroxyethyl cellulose, hydroxyethyl methylcellulose, carboxymethyl cellulose, or hydroxypropyl methylcellulose)) and a cross-linking agent (for example, a metal alkoxide, a diisocyanate compound, or a blocked diisocyanate compound).

<<Positive-Type Photosensitive Resin>>

The positive-type photosensitive resin may for example be a commonly known positive-type photoresist material such as a composition including a polymer (for example, a novolac resin, an acrylic copolymer resin, or a hydroxypolyamide) and a naphthoquinonediazide compound.

<<Negative-Type Photosensitive Resin>>

The negative-type photosensitive resin may for example be (i) a polymer having a photosensitive group introduced onto either or both of a main chain and a side chain thereof, (ii) a composition including a binder resin (polymer) and a cross-linking agent, or (iii) a composition including a photopolymerization initiator and either or both of a (meth)acrylic monomer and a (meth)acrylic oligomer. The chemical reaction of the negative-type photosensitive resin is not specifically limited and may for example be photopolymerization through a photopolymerization initiator, photodimerization of stilbene, maleimide, or the like, or crosslinking through photolysis of an azide group, a diazirine group, or the like. Among these examples, photolysis of an azide group, a diazirine group, or the like is preferable in terms of curing reactivity as the reaction is not inhibited by oxygen and the resultant cured film has excellent solvent resistance, hardness, and scratch resistance.

<Other Components>

Other components that are optionally included in the transparent conductive film according to the present disclosure can be selected as appropriate depending on the objective, without any specific limitations, and examples thereof include a light stabilizer, an ultraviolet absorber, a light absorber, an antistatic agent, a lubricant, a leveling agent, a defoamer, a flame retardant, an infrared absorber, a surfactant, a viscosity modifier such as a thickener, a dispersant, a curing accelerator catalyst, a plasticizer, an antioxidant, and a sulfurization inhibitor. Any one of such other components may be used individually, or any two or more of such other components may be used in combination.

(Electrode Production Method)

An electrode production method according to the present disclosure includes a step of forming the above-described transparent conductive film according to the present disclosure on a substrate (transparent conductive film formation step) and does not include a pressing step after the transparent conductive film formation step. Through the electrode production method according to the present disclosure, a transparent conductive film is formed using the metal nanowire bodies having the colored compound that includes the first dye adsorbed thereon and, as a result, it is possible to obtain an electrode that has excellent long-term conductivity, even when exposed to harsh conditions, without the need to perform a pressing step such as a calendering step.

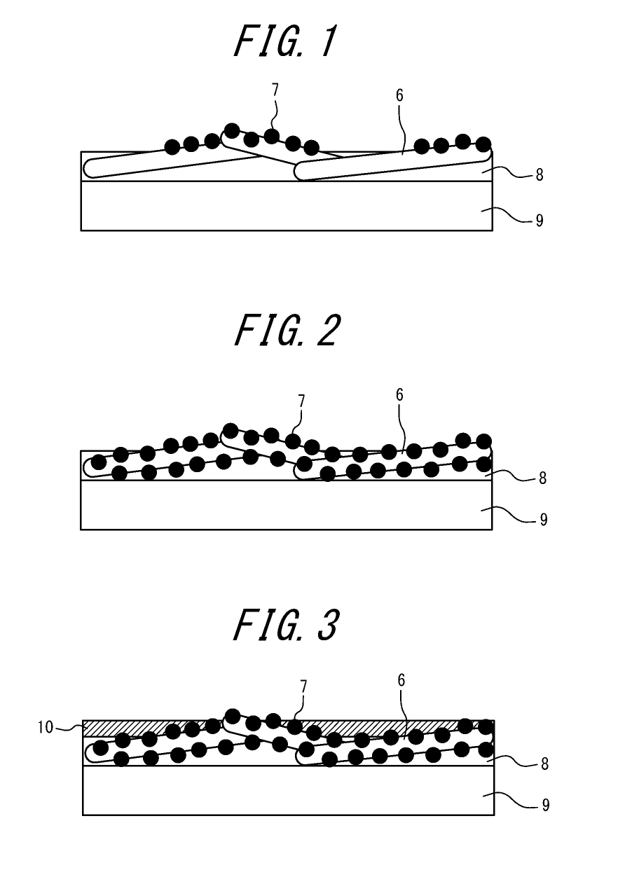

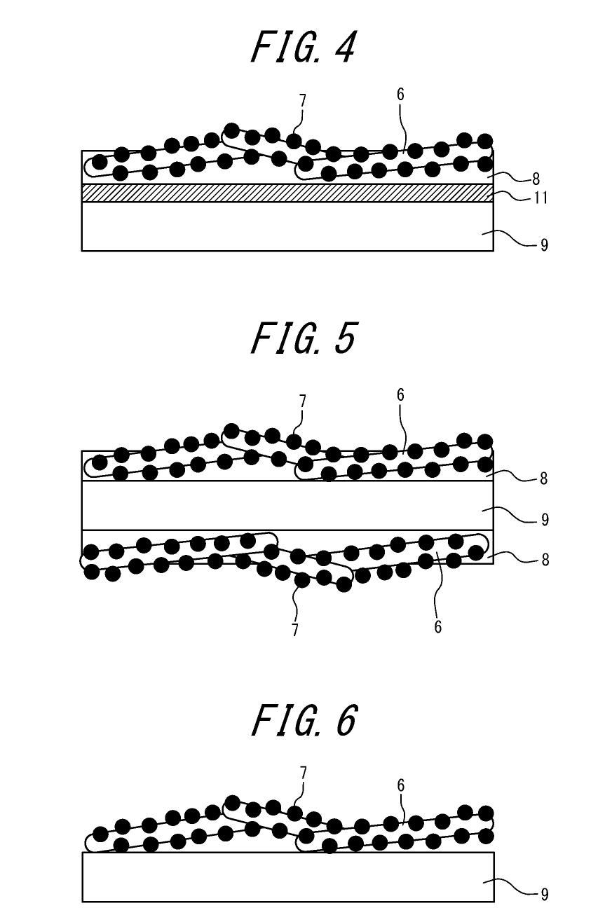

Examples of electrodes that can be produced by the electrode production method according to the present disclosure include (i) an electrode such as illustrated in FIG. 1 in which a colored compound (dye) 7 is only adsorbed onto exposed sections of metal nanowire bodies 6 in a binder layer 8 that serves as the transparent conductive film (the colored compound (dye) 7 is adsorbed onto the metal nanowire bodies 6, and may be present on part of the surface of the binder layer 8 or within the binder layer 8), (ii) an electrode such as illustrated in FIG. 2 in which metal nanowire bodies 6 having a colored compound 7 adsorbed thereon are dispersed in a binder layer 8 that is formed on a substrate 9 as the transparent conductive film, (iii) an electrode such as illustrated in FIG. 3 in which an overcoating layer 10 is formed on a binder layer 8 that serves as the transparent conductive film, (iv) an electrode such as illustrated in FIG. 4 in which an anchor layer 11 is formed between a substrate 9 and a binder layer 8 that serves as the transparent conductive film, (v) an electrode such as illustrated in FIG. 5 in which a binder layer 8 including metal nanowire bodies 6 having a colored compound 7 adsorbed thereon, which serves as the transparent conductive film, is formed on both surfaces of a substrate 9, (vi) an electrode such as illustrated in FIG. 6 in which metal nanowire bodies 6 having a colored compound 7 adsorbed thereon (i.e., metal nanowires) are accumulated on top of a substrate 9 to form the transparent conductive film without the colored compound 7 being dispersed in a binder, and (vii) an electrode that is an appropriate combination of any of (i) to (vi).

The following describes an electrode production method according to one embodiment of the present disclosure.

The electrode production method according to one embodiment of the present disclosure includes a transparent conductive film formation step that includes a dispersion film formation process and a curing process, and may further include an overcoating layer formation step and a pattern electrode formation step as necessary. Furthermore, the production method does not include a pressing step such as a calendering step (a step that is carried out to improve surface smoothness and impart glossiness on the surface in order to lower a sheet resistance value of the transparent conductive film) after the transparent conductive film formation step.

<Dispersion Film Formation Process of Transparent Conductive Film Formation Step>

The dispersion film formation process may for example be a process involving preparing (i) a dispersion liquid containing metal nanowires, a binder, and a solvent (i.e., a dispersion liquid in which a colored compound is adsorbed onto metal nanowire bodies) or (ii) a dispersion liquid containing a colored compound, metal nanowire bodies, a binder, and a solvent (i.e., a dispersion liquid in which the colored compound in not adsorbed onto the metal nanowire bodies), and after the colored compound has been adsorbed onto the metal nanowire bodies in the dispersion liquid, forming a dispersion film on a substrate using the dispersion liquid.

The metal nanowire bodies, the metal nanowires, the colored compound, and the binder are the same as described above and the solvent is as described below.

Formation of the dispersion film is preferably performed by a wet film formation method from a viewpoint of physical properties, convenience, production cost, and so forth. The wet film formation method can be selected as appropriate depending on the objective, without any specific limitations, and may for example be a commonly known method such as a coating method, a spraying method, or a printing method.

The coating method can be selected as appropriate depending on the objective, without any specific limitations, and may for example be micro gravure coating, wire bar coating, direct gravure coating, die coating, dipping, spray coating, reverse roll coating, curtain coating, comma coating, knife coating, or spin coating.

The spraying method can be selected as appropriate depending on the objective, without any specific limitations.

The printing method can be selected as appropriate depending on the objective, without any specific limitations, and may for example be relief printing, offset printing, gravure printing, intaglio printing, rubber plate printing, screen printing, or inkjet printing.

The mass per unit area of the metal nanowires that are applied onto the substrate can be selected as appropriate depending on the objective, without any specific limitations, and is preferably from 0.001 g/m² to 1.000 g/m².

As a result of the mass per unit area of the metal nanowires being at least 0.001 g/m², the metal nanowires are sufficiently present in the dispersion film and the resultant transparent conductive film can be provided with good conductivity. On the other hand, as a result of the mass per unit area of the metal nanowires being no greater than 1.000 g/m², reduction of total light transmittivity of the resultant transparent conductive film and worsening of haze can be suppressed.

For the same reasons, the mass per unit area of the metal nanowires is more preferably at least 0.003 g/m², and is also more preferably no greater than 0.3 g/m².

<<Substrate>>

The substrate can be selected as appropriate depending on the objective, without any specific limitations, and is preferably a transparent substrate made from a material that transmits visible light, such as an inorganic material or a plastic material. The transparent substrate is of a thickness required for an electrode including a transparent conductive film, and is for example a film shape (sheet shape) that is thin enough to exhibit flexible bending or a base plate shape that is thick enough to enable an appropriate degree of both bending and rigidity.

The inorganic material can be selected as appropriate depending on the objective, without any specific limitations, and may for example be quartz, sapphire, or glass.

The plastic material can be selected as appropriate depending on the objective, without any specific limitations, and may for example be a commonly known polymer material such as triacetyl cellulose (TAC), polyester (TPEE), polyethylene terephthalate (PET), polyethylene naphthalate (PEN), polyimide (PI), polyamide (PA), an aramid, polyethylene (PE), polyacrylate, polyether sulfone, polysulfone, polypropylene (PP), diacetyl cellulose, polyvinyl chloride, an acrylic resin (PMMA), polycarbonate (PC), an epoxy resin, a urea resin, a urethane resin, a melamine resin, or a cycloolefin polymer (COP). In a situation in which the transparent substrate is made from the plastic material, the transparent substrate preferably has a thickness of from 5 μm to 500 μm from a viewpoint of producibility, but is not specifically limited to this range.

<<Solvent>>

The solvent contained in the dispersion liquid can be a solvent that enables dispersion of the metal nanowires having the colored compound adsorbed thereon, and may for example be at least one selected from the group consisting of water, an alcohol (for example, methanol, ethanol, n-propanol, i-propanol, n-butanol, i-butanol, sec-butanol, or tert-butanol), a ketone (for example, cyclohexanone or cyclopentanone), an amide (for example, N,N-dimethylformamide (DMF)), and a sulfide (for example, dimethyl sulfoxide (DMSO)).

In order to inhibit uneven drying, cracking, and whitening of the dispersion film formed using the dispersion liquid, a high-boiling point solvent may be added to the dispersion liquid in order to control the rate of solvent evaporation from the dispersion liquid. The high-boiling point solvent may for example be butyl cellosolve, diacetone alcohol, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, or methyl glycol. Any one of these high-boiling point solvents may be used individually, or a plurality of these high-boiling point solvents may be used in combination.

<Curing Process of Transparent Conductive Film Formation Step>

The curing process is a process in which the dispersion film that has been formed on the substrate is cured to yield a cured product.

In the curing process, solvent in the dispersion film that has been formed on the substrate is first removed by drying. Removal of the solvent by drying may be carried out by natural drying or heated drying. After the drying, curing treatment of the uncured binder is carried out such that the metal nanowires are in a dispersed state in the cured binder. The curing treatment can be carried out by heating and/or irradiation with activating energy rays.

<Overcoating Layer Formation Step>

The overcoating layer formation step is a step in which an overcoating layer is formed on the cured product after the cured product has been formed from the dispersion film.

The overcoating layer can for example be formed by applying a coating liquid for overcoating layer formation that contains a specific material onto the cured product and curing the applied coating liquid. It is important that the overcoating layer displays light transmittivity with respect to visible light. The overcoating layer is preferably made from a polyacrylic-based resin, a polyamide-based resin, a polyester-based resin, or a cellulosic resin, or from a metal alkoxide hydrolysis or dehydration condensation product. The overcoating layer is preferably of a thickness that does not impair light transmittivity with respect to visible light. The overcoating layer preferably has one or more functions selected from the group of functions consisting of hard coating, glare prevention, reflection prevention, Newton ring prevention, and blocking prevention.

<Pattern Electrode Formation Step>

The pattern electrode formation step is a step in which a pattern electrode is formed by a commonly known photolithographic process after the transparent conductive film has been formed on the substrate. Through this step, the transparent conductive film according to the present disclosure can be adopted in a sensor electrode for a capacitive touch panel. In a situation in which the curing treatment in the curing process involves irradiation with activating energy rays, the curing treatment may be used for mask exposure/development in formation of the pattern electrode. Furthermore, patterning may be performed by laser etching.

(Structure)

A structure according to the present disclosure includes at least a substrate and the above-described transparent conductive film according to the present disclosure on the substrate, and may further include other optional components such as a protective resist or a hard coating material as necessary. As a result of the structure according to the present disclosure including the transparent conductive film that includes the metal nanowires having the colored compound including the first dye adsorbed thereon, the structure according to the present disclosure suppresses deterioration of display characteristics due to reduced contrast and has excellent conductivity.

No specific limitations are placed on the aforementioned structure other than being a structure that includes the transparent conductive film according to the present disclosure on a substrate. In other words, the structure according to the present disclosure is inclusive of any structure that includes a substrate, the transparent conductive film according to the present disclosure on the substrate, and one or more optional components.

(Information input device)

An information input device according to the present disclosure includes at least the above-described structure according to the present disclosure, and may optionally include other commonly known components. The information input device according to the present disclosure has high performance as a result of including the structure according to the present disclosure.

The information input device can be selected as appropriate depending on the objective, without any specific limitations, and may for example be a touch panel or the like such as described in Japanese Patent No. 4893867.

### EXAMPLES

The following provides a more specific description of the present disclosure through examples and comparative examples. However, the present disclosure is not limited to the following examples.

### Example 1

### Preparation of Metal Nanowire Body Dispersion Liquid

Silver nanowires AgNW-25 (average diameter: 25 nm, average length: 23 μm) produced by Seashell Technology, LLC. were used as metal nanowire bodies and these metal nanowire bodies were dispersed in water by a standard method to obtain a metal nanowire body dispersion liquid.

<Preparation of First Dye>

A mixed solution was obtained by mixing Alcian Blue 8GX produced by Sigma-Aldrich Co. LLC. and sodium 3-mercapto-1-propanesulfonate produced by Wako Pure Chemical Industries, Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield a dye [A] as a first dye forming a colored compound. The dye [A] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [A] had a number-average molecular mass of 1,775 measured as a polystyrene-converted value by GPC.

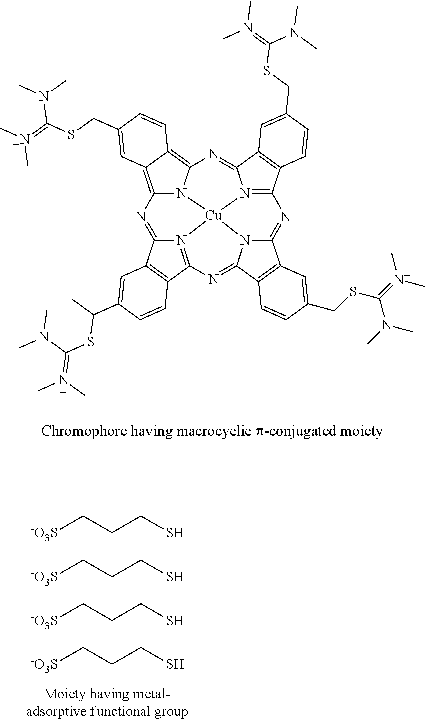

<Preparation of Dispersion Liquid for Coating>

The dye [A] was added in an amount of 10 mg to 10 g of a solvent of 1:1 (mass ratio) water/ethylene glycol and was dissolved using an ultrasonic cleaner for 60 minutes. Thereafter, the resultant solution was filtered using a PTFE filter having a pore diameter of 0.2 μm to obtain a colored compound solution as the filtrate. Next, 2 g of the previously described metal nanowire body dispersion liquid (metal nanowire body solid content: 0.5 mass %) was added to the colored compound solution and stirring was performed for 12 hours at room temperature in order to cause adsorption of the dye [A] onto the metal nanowire bodies, and thereby obtain a metal nanowire dispersion liquid. Thereafter, the resultant metal nanowire dispersion liquid was added into a fluorine resin filter paper tube (product name: No. 89) produced by Advantec MFS, Inc. and washing was performed repeatedly using a solvent of 3:1 (mass ratio) water/ethanol until the filtrate appeared colorless and transparent to the naked eye.

The metal nanowire dispersion liquid obtained through the above process was mixed with other materials in the amounts shown below to prepare a dispersion liquid for coating.

Metal nanowire dispersion liquid: 0.06 mass % (in terms of net mass of metal nanowire bodies)

Hydroxypropyl methylcellulose (produced by Sigma-Aldrich Co. LLC.): 0.09 mass %

Water: 89.85 mass %

Ethanol: 10 mass %

<Formation of Transparent Conductive Film>

The prepared dispersion liquid was coated onto a transparent substrate by a 10 count coil bar to form a dispersion film. In this coating, the silver nanowires were applied with a mass per unit area of 0.012 g/m². The transparent substrate was a PET substrate (produced by Toray Industries, Inc., product name: Lumirror U34, thickness: 125 μm). Next, a dryer was used to blow warm air onto the surface on which the dispersion film had been formed on the transparent substrate in order to remove solvent from the dispersion film, and drying was subsequently performed for 5 minutes at 120° C. to form a transparent conductive film.

### Example 2

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [B] was prepared by the following method.

<Preparation of First Dye>

A mixed solution was obtained by mixing 5,10,15,20-tetrakis(1-methyl-4-pyridinio)porphyrin tetra(p-toluenesulfonate) produced by Sigma-Aldrich Co. LLC. and sodium 3-mercapto-1-propanesulfonate produced by Wako Pure Chemical Industries, Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [B] as the first dye forming the colored compound. The dye [B] was represented by the structural formula shown below and included a chromophore having a macrocyclic π-conjugated moiety in the form of a porphyrin (although not specifically illustrated in the structural formula shown below, each cation of the chromophore actually forms an ionic bond with an anion of a moiety having a metal-adsorptive functional group). The dye [B] had a number-average molecular mass of 1,299 measured as a polystyrene-converted value by GPC.

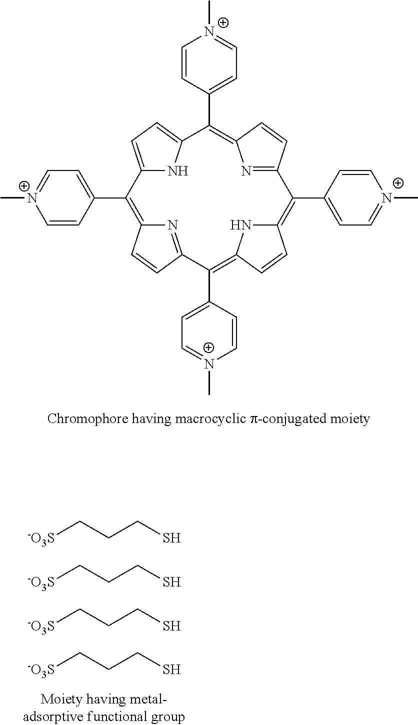

### Example 3

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [C] was prepared by the following method.

<Preparation of First Dye>

A mixed solution was obtained by mixing copper phthalocyanine-tetra sulfonic acid tetrasodium salt produced by Sigma-Aldrich Co. LLC. and 2-aminoethanol hydrochloride produced by Tokyo Chemical Industry Co., Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [C] as the first dye forming the colored compound. The dye [C] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [C] had a number-average molecular mass of 1,135 measured as a polystyrene-converted value by GPC.

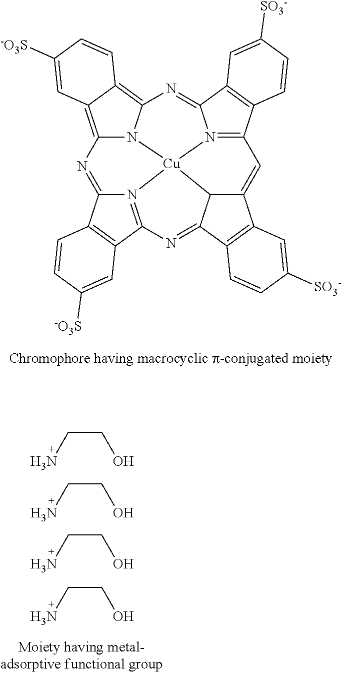

### Example 4

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [D] was prepared by the following method.

<Preparation of First Dye>

A mixed solution was obtained by mixing Alcian Blue 8GX produced by Sigma-Aldrich Co. LLC. and sodium butanesulfonate produced by Tokyo Chemical Industry Co., Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [D] as the first dye forming the colored compound. The dye [D] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [D] had a number-average molecular mass of 1,704 measured as a polystyrene-converted value by GPC.

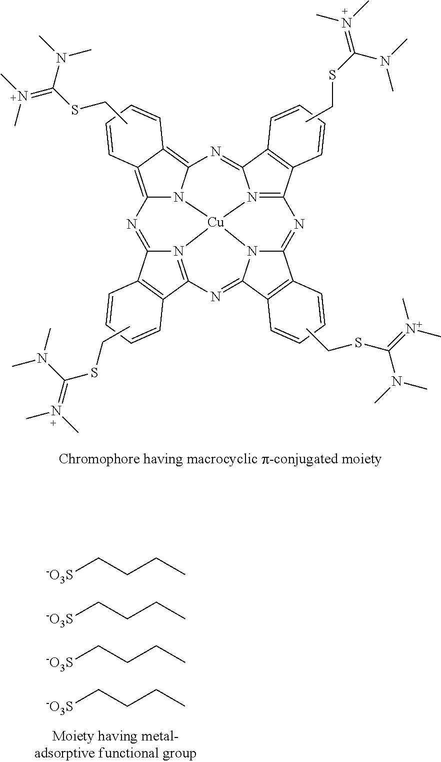

### Example 5

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [E] was prepared by the following method.

<Preparation of First Dye>

A mixed solution was obtained by mixing Alcian Blue-tetrakis(methylpyridinium) chloride produced by Sigma-Aldrich Co. LLC. and disodium 1,2-ethanedisulfonate produced by Tokyo Chemical Industry Co., Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [E] as the first dye forming the colored compound. The dye [E] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [E] had a number-average molecular mass of 1,320 measured as a polystyrene-converted value by GPC.

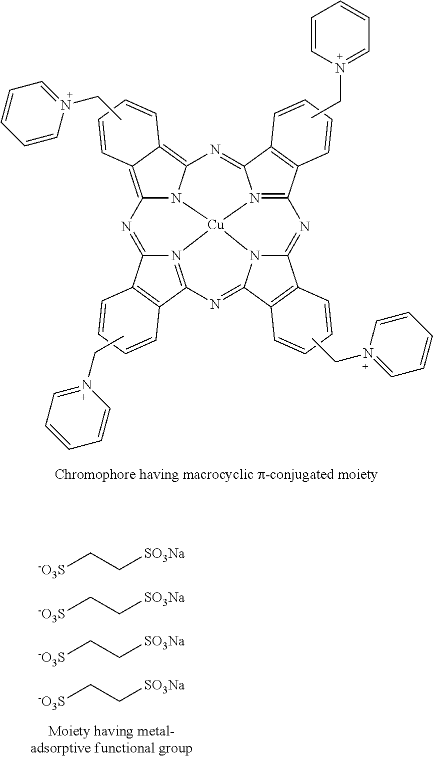

### Example 6

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [F] was prepared by the following method.

<Preparation of First Dye>

A mixed solution was obtained by mixing Alcian Blue-tetrakis(methylpyridinium) chloride produced by Sigma-Aldrich Co. LLC. and sodium isethionate produced by Tokyo Chemical Industry Co., Ltd. with a 1:2 mass ratio in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [F] as the first dye forming the colored compound. The dye [F] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [F] had a number-average molecular mass of 1,444 measured as a polystyrene-converted value by GPC.

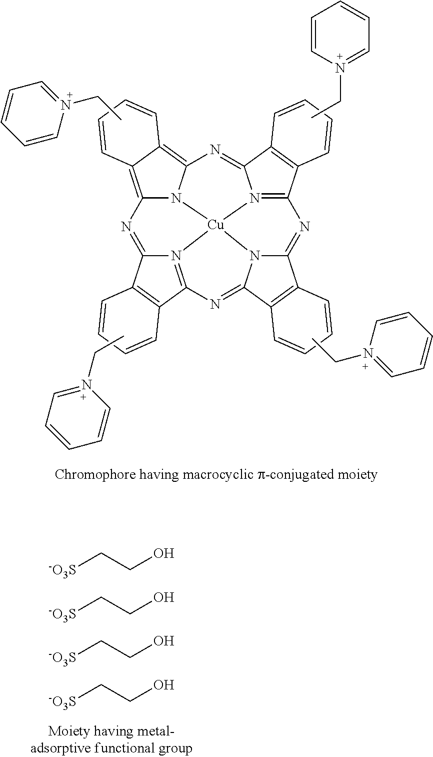

### Example 7

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [G] was prepared by the following method.

<Preparation of First Dye>

A mixed solution was obtained by mixing Alcian Blue-tetrakis(methylpyridinium) chloride produced by Sigma-Aldrich Co. LLC. and potassium 3-(methacryloyloxy)propanesulfonate produced by Tokyo Chemical Industry Co., Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [G] as the first dye forming the colored compound. The dye [G] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [G] had a number-average molecular mass of 1,772 measured as a polystyrene-converted value by GPC.

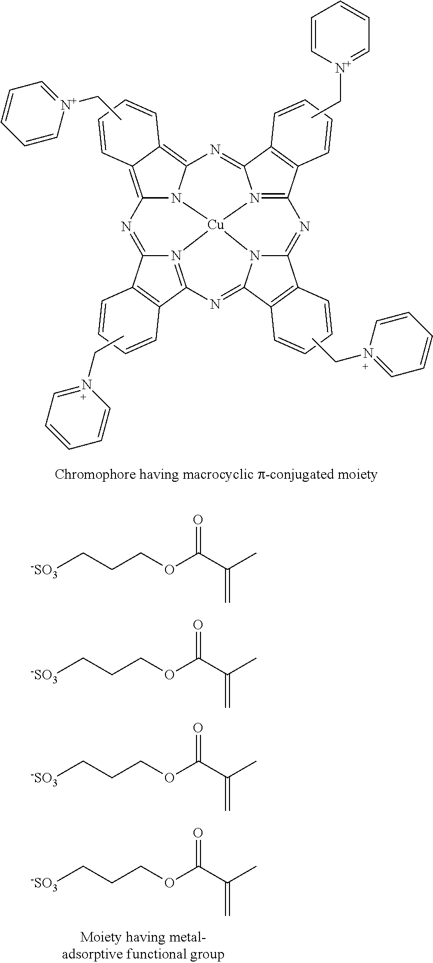

### Example 8

Preparation of a metal nanowire body dispersion liquid, preparation of a dispersion liquid for coating, and formation of a transparent conductive film were performed in the same way as in Example 1 with the exception that instead of preparing the dye [A] as the first dye forming the colored compound as in Example 1, a dye [H] was prepared by the following method.

<Preparation of First Dye>

Trimellitic anhydride, urea, ammonium molybdate, and zinc chloride were added to nitrobenzene, were stirred and heated under reflux, and a precipitate was collected. Next, sodium hydroxide was added to the precipitate to cause hydrolysis thereof and then hydrochloric acid was added in order to provide acidic conditions and thereby yield zinc phthalocyanine tetracarboxylic acid.

A mixed solution was obtained by mixing the zinc phthalocyanine tetracarboxylic acid and 2-aminoethanethiol produced by Tokyo Chemical Industry Co., Ltd. with a mass ratio of 1:2 in methanol solvent. Next, the mixed solution was caused to react for 60 minutes using an ultrasonic cleaner and the resultant reaction liquid was subsequently filtered using a PTFE filter having a pore diameter of 3 μm to obtain a solid. The filtered-off solid was washed three times with methanol and was then dried under reduced pressure to yield the aforementioned dye [H] as the first dye forming the colored compound. The dye [H] was represented by the structural formula shown below and included a chromophore having a macrocyclic π-conjugated moiety in the form of a phthalocyanine (although not specifically illustrated in the structural formula shown below, each cation of the chromophore actually forms an ionic bond with an anion of a moiety having a metal-adsorptive functional group). The dye [H] had a number-average molecular mass of 1,056 measured as a polystyrene-converted value by GPC.

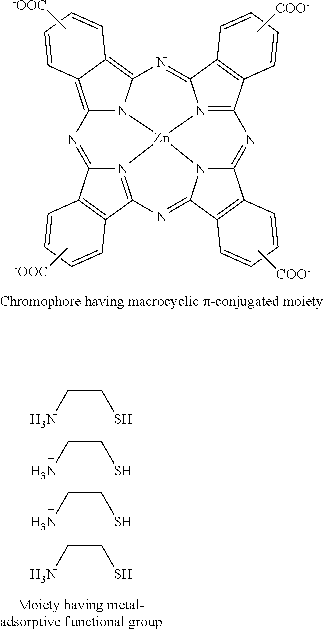

### Example 9

Preparation of a metal nanowire body dispersion liquid, preparation of a dispersion liquid for coating, and formation of a transparent conductive film were performed in the same way as in Example 1 with the exception that AgNW-25 used as the metal nanowire bodies in Example 1 was replaced with silver nanowires AW-030 (average diameter: 30 nm, average length: 20 μm) produced by Zhejiang Kechuang Advanced Materials Co.

### Example 10

Preparation of a metal nanowire body dispersion liquid, preparation of a dispersion liquid for coating, and formation of a transparent conductive film were performed in the same way as in Example 1 with the exception that AgNW-25 used as the metal nanowire bodies in Example 1 was replaced with silver nanowires Agnws-40 (average diameter: 40 nm, average length: 30 μm or greater) produced by ACS Material.

### Example 11

Preparation of a metal nanowire body dispersion liquid, preparation of a dispersion liquid for coating, and formation of a transparent conductive film were performed in the same way as in Example 1 with the exception that AgNW-25 used as the metal nanowire bodies in Example 1 was replaced with copper nanowires NovaWireCu01 (average diameter: 100 nm, average length: 30 μm) produced by Novarials Corporation.

### Comparative Example 1

Preparation of a dispersion liquid for coating and formation of a transparent conductive film were performed in the same way as in Example 1 with the exception that the first dye was not prepared and the dispersion liquid for coating was prepared using the metal nanowire body dispersion liquid instead of the metal nanowire dispersion liquid used in Example 1.

### Comparative Example 2

Preparation of a dispersion liquid for coating and formation of a transparent conductive film were performed in the same way as in Example 9 with the exception that the first dye was not prepared and the dispersion liquid for coating was prepared using the metal nanowire body dispersion liquid instead of the metal nanowire dispersion liquid used in Example 9.

### Comparative Example 3

Preparation of a dispersion liquid for coating and formation of a transparent conductive film were performed in the same way as in Example 10 with the exception that the first dye was not prepared and the dispersion liquid for coating was prepared using the metal nanowire body dispersion liquid instead of the metal nanowire dispersion liquid used in Example 10.

### Comparative Example 4

Preparation of a dispersion liquid for coating and formation of a transparent conductive film were performed in the same way as in Example 1 with the exception that instead of preparing the first dye and causing adsorption of the first dye onto the metal nanowire bodies as in Example 1, a dye [I] was prepared as a second dye by the following method and the second dye was caused to adsorb onto the metal nanowire bodies.

<Preparation of Second Dye>

A mixed solution was obtained by mixing Lanyl Black BG E/C produced by Taoka Chemical Co., Ltd. and 2-aminoethanethiol hydrochloride produced by Wako Pure Chemical Industries, Ltd. with a mass ratio of 4:1 in water solvent. Next, the mixed solution was caused to react for 100 minutes using an ultrasonic cleaner and was then left for 15 hours. The resultant reaction solution was subsequently filtered using a mixed cellulose ester type membrane filter having a pore diameter of 3 μm to obtain a solid. The filtered-off solid was washed three times with water and was then dried at 100° C. in a vacuum oven to yield the aforementioned dye [I] as the second dye forming the colored compound. The dye [I] was represented by the structural formula shown below and did not include a macrocyclic π-conjugated moiety. The dye [I] had a number-average molecular mass of 996 measured as a polystyrene-converted value by GPC.

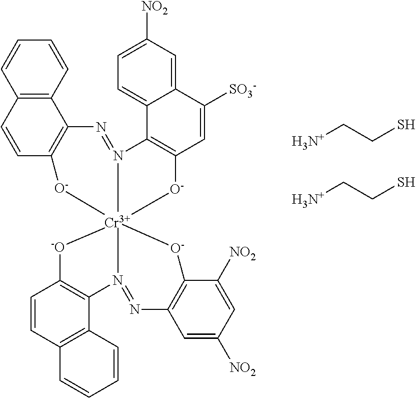

### Reference Example 1

The transparent conductive film formed in Comparative Example 4 was subjected to calendering with a nip width of 1 mm, a load of 4 kN, and a speed of 1 m/minute in order to form a calendered transparent conductive film.

### Comparative Example 5

Preparation of a dispersion liquid for coating and formation of a transparent conductive film were performed in the same way as in Example 11 with the exception that the first dye was not prepared and the dispersion liquid for coating was prepared using the metal nanowire body dispersion liquid instead of the metal nanowire dispersion liquid used in Example 11.

### Example 12

Preparation of a dispersion liquid for coating and formation of a transparent conductive film were performed in the same way as in Example 1 with the exception that 10 mg of the dye [A] used as the first dye in Example 1 was replaced with 10 mg of a composite compound prepared by the following method.

<Preparation of Composite Compound>

A mixed solution was obtained by mixing the dye [A] as the first dye prepared in the same way as in Example 1 and Acid Violet 49 produced by Tokyo Chemical Industry Co., Ltd. as a second dye with a mass ratio of 1:2 in water solvent. Next, the mixed solution was subjected to an ultrasonic cleaner for 100 minutes in order to cause a reaction of part of the first dye and part of the second dye. Thereafter, the resultant reaction liquid was filtered using a PTFE filter having a pore diameter of 3 μm to obtain a solid. The filtered-off solid was vacuum dried to yield the aforementioned composite compound. The Acid Violet 49 was represented by the structural formula shown below and included a chromophore that absorbs visible region light in the form of a triphenylmethane derivative. The Acid Violet 49 had a number-average Molecular mass of 733 measured as a polystyrene-converted value by GPC.

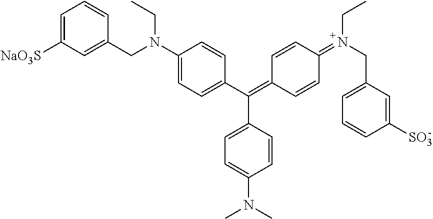

### Example 13

Preparation of a dispersion liquid for coating and formation of a transparent conductive film were performed in the same way as in Example 2 with the exception that 10 mg of the dye [B] used as the first dye in Example 2 was replaced with 10 mg of a composite compound prepared by the following method.

<Preparation of Composite Compound>

A mixed solution was obtained by mixing the dye [B] as the first dye prepared in the same way as in Example 2 and Acid Red 9 produced by Tokyo Chemical Industry Co., Ltd. as a second dye with a mass ratio of 1:2 in water solvent. Next, the mixed solution was subjected to an ultrasonic cleaner for 100 minutes in order to cause a reaction of part of the first dye and part of the second dye. Thereafter, the resultant reaction liquid was filtered using a PTFE filter having a pore diameter of 3 μm to obtain a solid. The filtered-off solid was vacuum dried to yield the aforementioned composite compound. The Acid Red 9 was represented by the structural formula shown below and included a chromophore that absorbs visible region light in the form of an azo compound. The Acid Red 9 had a number-average molecular mass of 400 measured as a polystyrene-converted value by GPC.

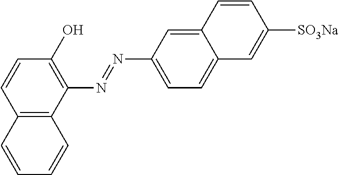

### Example 14

Preparation of a composite compound, preparation of a dispersion liquid for coating, and formation of a transparent conductive film were performed in the same way as in Example 12 with the exception that Acid Violet 49 used in Example 12 was replaced with Brilliant Blue G produced by Tokyo Chemical Industry Co., Ltd. as the second dye. The Brilliant Blue G was represented by the structural formula shown below and included a chromophore that absorbs visible region light in the form of a triphenylmethane derivative. The Brilliant Blue G had a number-average molecular mass of 854 measured as a polystyrene-converted value by GPC.

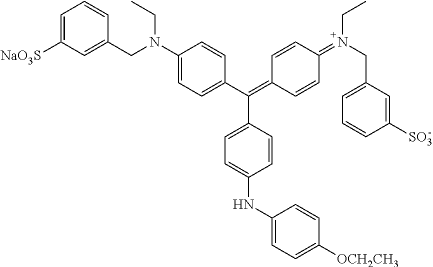

### Example 15

Preparation of a metal nanowire body dispersion liquid, preparation of a composite compound, preparation of a dispersion liquid for coating, and formation of a transparent conductive film were performed in the same way as in Example 12 with the exception that AgNW-25 used as metal nanowire bodies in Example 12 was replaced with silver nanowires AW-030 (average diameter: 30 nm, average length: 20 μm) produced by Zhejiang Kechuang Advanced Materials Co.

### Comparative Example 6

Preparation of a metal nanowire body dispersion liquid, preparation of a dispersion liquid for coating, and formation of a transparent conductive film were performed in the same way as in Example 12 with the exception that the composite compound in Example 12 was replaced with a dye [J] as a second dye prepared by the following method.

<Preparation of Second Dye>

A mixed solution was obtained by mixing Acid Violet 49 produced by Tokyo Chemical Industry Co., Ltd. and 2-aminoethanethiol hydrochloride produced by Wako Pure Chemical Industries, Ltd. with a mass ratio of 4:1 in water solvent. Next, the mixed solution was caused to react for 100 minutes using an ultrasonic cleaner and the resultant reaction liquid was subsequently filtered using a PTFE filter having a pore diameter of 3 μm to obtain a solid. The filtered-off solid was vacuum dried to obtain the aforementioned dye [J] as the second dye forming the colored compound.

### Reference Example 2

The transparent conductive film formed in Comparative Example 6 was subjected to calendering with a nip width of 1 mm, a load of 4 kN, and a speed of 1 m/minute in order to form a calendered transparent conductive film.

<<Evaluation>>

The transparent conductive films prepared in the examples, comparative examples, and reference examples described above were used to evaluate (A) total light transmittivity [%], (B) a haze value, (C) a sheet resistance value [Ω/sq.], (D) a Δreflection L* value, (E) a change in sheet resistance after an environment test, and (F) a change in sheet resistance after a Xe lamp irradiation test. These evaluations were performed as follows. The evaluation results are shown in Tables 1 and 2.

(A) Evaluation of Total Light Transmittivity

Total light transmittivity of each of the transparent conductive films was evaluated in accordance with JIS K7136 using an HM-150 (product name; produced by Murakami Color Research Laboratory Co., Ltd.). Higher total light transmittivity is more preferable from a viewpoint of display characteristics.

(B) Evaluation of Haze Value

A haze value of each of the transparent conductive films was evaluated in accordance with JIS K7136 using an HM-150 (product name; produced by Murakami Color Research Laboratory Co., Ltd.). A lower haze value is more preferable from a viewpoint of display characteristics.

(C) Evaluation of Sheet Resistance Value

A sheet resistance value of each of the transparent conductive films was evaluated using an EC-80P (product name; produced by Napson Corporation). A sheet resistance value of no greater than 200 [Ω/sq.] is preferable.

(D) Evaluation of Δreflection L* Value

A Δreflection L* value was evaluated by attaching black plastic tape (VT-50 produced by Nichiban Co., Ltd.) at the side at which the transparent conductive film was formed on the transparent substrate and performing evaluation from the opposite side to the side at which the transparent conductive film was formed in accordance with JIS Z8722 using a Color i5 produced by X-Rite Inc. A lower Δreflection L* value is more preferable from a viewpoint of display characteristics.

Herein, the Δreflection L* value can be calculated using the following formula.

ΔReflection L* value=(Reflection L* value of transparent electrode including substrate)−(Reflection L* value of substrate)

The light source used in measurement of the Δreflection L* value was a D65 light source. Furthermore, an average value of measurements performed at three arbitrary locations by an SCE (specular component excluded) method was taken to be the reflection L* value.

(E) Evaluation of Change in Sheet Resistance after Environment Test

A glass slide (product no.: 59213) produced by Matsunami Glass Ind., Ltd. was affixed to the surface at which the transparent conductive film was formed on the transparent substrate using adhesive film (product no.: 8146-2) produced by 3M. Next, the resultant product was placed in a glass slide holder and was left for 500 hours in an oven set to a temperature of 60° C. and a humidity of 90%. Thereafter, a sheet resistance value of the transparent conductive film was measured and the change in sheet resistance after the environment test was evaluated based on the following standard.

Good: Percentage change in sheet resistance value of transparent conductive film before and after test of less than 20%

Poor: Percentage change in sheet resistance value of transparent conductive film before and after test of 20% or greater

(F) Evaluation of Change in Sheet Resistance after Xe Lamp Irradiation Test

A glass slide (product no.: S9213) produced by Matsunami Glass Ind., Ltd. was affixed to the surface at which the transparent conductive film was formed on the transparent substrate using adhesive film (product no.: 8146-2) produced by 3M. Next, the resultant product was placed in a glass slide holder and was left in a Xe lamp light-resistance tester for 100 hours. Thereafter, a sheet resistance value of the transparent conductive film was measured and the change in sheet resistance after the Xe lamp irradiation test was evaluated based on the following standard.

Good: Percentage change in sheet resistance value of transparent conductive film before and after test of less than 20%

Poor: Percentage change in sheet resistance value of transparent conductive film before and after test of 20% or greater

TABLE 1

| | | | Example 1 | Example 2 | Example 3 | Example 4 | Example 5 | Example 6 |
|---|---|---|---|---|---|---|---|---|
| Metal | Type | | AgNW-25 | AgNW-25 | AgNW-25 | AgNW-25 | AgNW-25 | AgNW-25 |
| nanowire | Constituent metal | | Silver | Silver | Silver | Silver | Silver | Silver |
| bodies | | | | | | | | |
| Colored | First | Type | Dye [A] | Dye [B] | Dye [C] | Dye [D] | Dye [E] | Dye [F] |
| compound | dye | Macrocyclic | Phthalo- | Porphyrin | Phthalo- | Phthalo- | Phthalo- | Phthalo- |
| | | π-conjugated | cyanine | | cyanine | cyanine | cyanine | cyanine |
| | | moiety | | | | | | |
| | | Number- | 1,775 | 1,299 | 1,135 | 1,704 | 1,320 | 1,444 |
| | | average | | | | | | |
| | | molecular | | | | | | |
| | | mass | | | | | | |
| | Second | Type | — | — | — | — | — | — |
| | dye | Chromophore | | | | | | |
| | | Number- | | | | | | |
| | | average | | | | | | |
| | | molecular | | | | | | |
| | | mass | | | | | | |

| | | | | | | | |
|---|---|---|---|---|---|---|---|
| Electrode | Presence of pressing | No | No | No | No | No | No |
| production | step | | | | | | |

| | | | | | | |
|---|---|---|---|---|---|---|
| (A) Total light transmittivity [%] | 92.0 | 92.0 | 91.9 | 92.0 | 91.9 | 91.8 |
| (B) Haze value [—] | 0.9 | 0.9 | 0.9 | 0.9 | 0.9 | 0.9 |
| (C) Sheet resistance value [Ω/sq.] | 100 | 100 | 100 | 100 | 100 | 100 |
| (D) ΔReflection L* value | 1.7 | 1.7 | 1.7 | 1.7 | 1.7 | 1.7 |
| (E) Change in sheet resistance | Good | Good | Good | Good | Good | Good |
| after environment test | | | | | | |
| (F) Change in sheet resistance | Good | Good | Good | Good | Good | Good |
| after Xe lamp irradiation test | | | | | | |

| | | | Example 7 | Example 8 | Example 9 | Example 10 | Example 11 |
|---|---|---|---|---|---|---|---|
| Metal | Type | | AgNW-25 | AgNW-25 | AW-030 | Agnws-40 | NovaWireCu01 |
| nanowire | Constituent metal | | Silver | Silver | Silver | Silver | Copper |
| bodies | | | | | | | |
| Colored | First | Type | Dye [G] | Dye [H] | Dye [A] | Dye [A] | Dye [A] |
| compound | dye | Macrocyclic | Phthalo- | Phthalo- | Phthalo- | Phthalo- | Phthalo- |
| | | π-conjugated | cyanine | cyanine | cyanine | cyanine | cyanine |
| | | moiety | | | | | |
| | | Number- | 1,772 | 1,056 | 1,775 | 1,775 | 1,775 |
| | | average | | | | | |
| | | molecular | | | | | |
| | | mass | | | | | |
| | Second | Type | — | — | — | — | — |
| | dye | Chromophore | | | | | |
| | | Number- | | | | | |
| | | average | | | | | |
| | | molecular | | | | | |
| | | mass | | | | | |

| | | | | | | |
|---|---|---|---|---|---|---|
| Electrode | Presence of pressing | No | No | No | No | No |
| production | step | | | | | |

| | | | | | |
|---|---|---|---|---|---|
| (A) Total light transmittivity [%] | 91.9 | 92.0 | 91.7 | 91.5 | 88.5 |
| (B) Haze value [—] | 0.9 | 0.9 | 1.0 | 1.5 | 2.0 |
| (C) Sheet resistance value [Ω/sq.] | 100 | 100 | 100 | 100 | 100 |
| (D) ΔReflection L* value | 1.7 | 1.7 | 2.0 | 3.2 | 4 |
| (E) Change in sheet resistance | Good | Good | Good | Good | Good |
| after environment test | | | | | |
| (F) Change in sheet resistance | Good | Good | Good | Good | Good |
| after Xe lamp irradiation test | | | | | |

TABLE 2

| | | | Comparative | Comparative | Comparative | Comparative | Reference | Comparative | |
|---|---|---|---|---|---|---|---|---|---|
| | | | Example 1 | Example 2 | Example 3 | Example 4 | Example 1 | Example 5 | Example 12 |
| Metal | Type | | AgNW-25 | AW-030 | Agnws-40 | AgNW-25 | AgNW-25 | NovaWireCu01 | AgNW-25 |
| nanowire | Constituent metal | | Silver | Silver | Silver | Silver | Silver | Copper | Silver |
| bodies | | | | | | | | | |
| Colored | First | Type | — | — | — | — | — | — | Dye [A] |
| compound | dye | Macrocyclic | | | | | | | Phthalo- |
| | | π-conjugated | | | | | | | cyanine |
| | | moiety | | | | | | | |
| | | Number- | | | | | | | 1,775 |
| | | average | | | | | | | |
| | | molecular | | | | | | | |
| | | mass | | | | | | | |
| | Second | Type | — | — | — | Dye [I] | Dye [I] | — | Acid |
| | dye | | | | | | | | Violet 49 |
| | | Chromophore | | | | Chromium- | Chromium- | | Triphenyl- |
| | | | | | | containing | containing | | methane |
| | | | | | | complex | complex | | derivative |
| | | Number- | | | | 996 | 996 | | 733 |
| | | average | | | | | | | |
| | | molecular | | | | | | | |
| | | mass | | | | | | | |

| | | | | | | | | |
|---|---|---|---|---|---|---|---|---|
| Electrode | Presence of pressing | No | No | No | No | Yes | No | No |
| production | step | | | | | | | |

| | | | | | | | |
|---|---|---|---|---|---|---|---|
| (A) Total light transmittivity [%] | 91.6 | 91.4 | 91.0 | 91.9 | 91.9 | 88 | 92.0 |
| (B) Haze value [—] | 1.1 | 1.2 | 2.0 | 0.9 | 0.9 | 3.3 | 0.9 |
| (C) Sheet resistance value [Ω/sq.] | 100 | 100 | 100 | 300 | 100 | 100 | 100 |
| (D) ΔReflection L* value | 2.5 | 2.9 | 4.1 | 1.7 | 1.7 | 5 | 1.4 |
| (E) Change in sheet resistance | Poor | Poor | Poor | Good | Good | Poor | Good |
| after environment test | | | | | | | |
| (F) Change in sheet resistance | Good | Good | Good | Good | Good | Poor | Good |
| after Xe lamp irradiation test | | | | | | | |

| | | | | | | Comparative | Reference |
|---|---|---|---|---|---|---|---|
| | | | Example 13 | Example 14 | Example 15 | Example 6 | Example 2 |
| Metal | Type | | AgNW-25 | AgNW-25 | AW-030 | AgNW-25 | AgNW-25 |
| nanowire | Constituent metal | | Silver | Silver | Silver | Silver | Silver |
| bodies | | | | | | | |
| Colored | First | Type | Dye [B] | Dye [A] | Dye [A] | — | — |
| compound | dye | Macrocyclic | Porphyrin | Phthalo- | Phthalo- | | |
| | | π-conjugated | | cyanine | cyanine | | |
| | | moiety | | | | | |
| | | Number- | 1,299 | 1,775 | 1,775 | | |
| | | average | | | | | |
| | | molecular | | | | | |
| | | mass | | | | | |
| | Second | Type | Acid Red 9 | Brilliant | Acid | Dye [J] | Dye [J] |
| | dye | | | Blue G | Violet 49 | | |
| | | Chromophore | Azo | Triphenyl- | Triphenyl- | Triphenyl- | Triphenyl- |
| | | | compound | methane | methane | methane | methane |
| | | | | derivative | derivative | derivative | derivative |
| | | Number- | 400 | 854 | 733 | 789 | 789 |
| | | average | | | | | |
| | | molecular | | | | | |
| | | mass | | | | | |

| | | | | | | |
|---|---|---|---|---|---|---|
| Electrode | Presence of pressing | No | No | No | No | Yes |
| production | step | | | | | |

| | | | | | |
|---|---|---|---|---|---|
| (A) Total light transmittivity [%] | 92.0 | 91.9 | 91.7 | 91.9 | 91.9 |
| (B) Haze value [—] | 0.9 | 0.9 | 1.0 | 0.9 | 0.9 |
| (C) Sheet resistance value [Ω/sq.] | 100 | 100 | 100 | 300 | 100 |
| (D) ΔReflection L* value | 1.6 | 1.5 | 1.6 | 1.8 | 1.8 |
| (E) Change in sheet resistance | Good | Good | Good | Poor | Good |
| after environment test | | | | | |
| (F) Change in sheet resistance | Good | Good | Good | Poor | Good |
| after Xe lamp irradiation test | | | | | |

Through comparison of Examples 1, 9, and 10 in Table 1 with Comparative Examples 1, 2, and 3, respectively, it can be seen that through use of metal nanowire bodies having a colored compound adsorbed thereon that includes a first dye such as described herein, better evaluation results can be achieved for total light transmittivity and haze value, and display characteristics can be improved. Moreover, Tables 1 and 2 show that in examples in which the transparent conductive film includes metal nanowire bodies having a colored compound adsorbed thereon that includes a first dye such as described herein, deterioration of display characteristics is suppressed, and excellent long-term conductivity is achieved, even when the transparent conductive film is exposed to harsh conditions.

Note that for the transparent conductive films in at least Comparative Examples 4 and 6, the sheet resistance value is large as a result of a colored compound including a first dye such as described herein not being used, and it is not possible to reduce the sheet resistance value without performing calendering (refer to Reference Examples 1 and 2).

Furthermore, through comparison of Examples 1-11 with Examples 12-15 in Tables 1 and 2, it can be seen that in the case of a transparent conductive film that includes metal nanowire bodies having a colored compound adsorbed thereon that includes a second dye such as described herein in addition to a first dye such as described herein, the good display characteristics and conductivity described above can be maintained while also achieving better optical characteristics, such as a Δreflection L* value.

### INDUSTRIAL APPLICABILITY

The transparent conductive film according to the present disclosure is particularly suitable for use in an information input device such as a touch panel, but is also suitable for applications other than touch panels (for example, organic EL electrodes, solar cell surface electrodes, transparent antennas (wireless antennas for charging in mobile telephones and smartphones), and transparent heaters that can be used for condensation prevention or the like).

1. A transparent conductive film comprising:
one or more metal nanowire bodies; and
a colored compound adsorbed onto the metal nanowire bodies, wherein
the colored compound includes a first dye that includes a macrocyclic π-conjugated moiety and a moiety having a functional group that exhibits adsorptivity with respect to a constituent metal of the metal nanowire bodies.

2. The transparent conductive film of claim 1, wherein
the functional group that exhibits adsorptivity with respect to the constituent metal is at least one selected from the group consisting of a sulfo group, a sulfonyl group, a sulfonamide group, a carboxylic acid group, an aromatic amino group, an amide group, a phosphate group, a phosphino group, a silanol group, an epoxy group, an isocyanate group, a cyano group, a vinyl group, a thiol group, a sulfide group, a carbinol group, an ammonium group, a pyridinium group, a hydroxy group, and a methyl group.

3. The transparent conductive film of claim 1, wherein
the number of functional groups in the first dye that exhibit adsorptivity with respect to the constituent metal is at least two per each macrocyclic π-conjugated moiety in the first dye.

4. The transparent conductive film of claim 1, wherein
the macrocyclic π-conjugated moiety is at least one selected from the group consisting of a porphyrin, a chlorin, a corrole, a norcorrole, a subporphyrin, a phthalocyanine, a naphthalocyanine, a subphthalocyanine, an anthracocyanine, a tetraazaporphyrin, a bacteriochlorin, and a benzoporphyrin.

5. The transparent conductive film of claim 1, wherein
the first dye has a number-average molecular mass of from 1,000 to 2,000.

6. The transparent conductive film of claim 1, wherein
the colored compound further includes a second dye including a chromophore that absorbs visible region light, but does not have a macrocyclic π-conjugated moiety, and a moiety having a functional group that exhibits adsorptivity with respect to the constituent metal of the metal nanowire bodies.

7. The transparent conductive film of claim 6, wherein
the chromophore that absorbs visible region light, but does not have a macrocyclic π-conjugated moiety, is at least one selected from the group consisting of a stilbene derivative, an indophenol derivative, a diphenylmethane derivative, an anthraquinone derivative, a triphenylmethane derivative, a diazine derivative, an indigoid derivative, a xanthene derivative, an oxazine derivative, an acridine derivative, a thiazine derivative, an azo compound, and a metal-containing complex.

8. The transparent conductive film of claim 6, wherein
either or both of the first dye and the second dye have a number-average molecular mass of from 1,000 to 2,000.

9. The transparent conductive film of claim 1, wherein
the constituent metal of the metal nanowire bodies is silver.

10. An electrode production method comprising
forming the transparent conductive film of claim 1 on a substrate, wherein
pressing is not performed after the forming of the transparent conductive film.

11. A structure comprising:
a substrate; and
the transparent conductive film of claim 1 on the substrate.

12. An information input device comprising the structure of claim 11.
